(19) United States
(12) Patent Application Publication
(10) Pub. No.: US 2006/0080486 A1
(43) Pub. Date: Apr. 13, 2006

(54) Method and apparatus for prioritizing requests for information in a network environment

(75) Inventor: Shunguo Yan, Austin, TX (US)

Correspondence Address: MARK P. KAHLER, 8101 VAILVIEW COVE, AUSTIN, TX, 78750, US

(73) Assignee: International Business Machines Corporation, Armonk, NY (US)

(21) Appl. No.: 10/960,585

(22) Filed: Oct. 7, 2004

(51) Int. Cl. G06F 13/368

(52) U.S. Cl. 710/123

(57) ABSTRACT

A network system is disclosed in which requests for access to a shared resource are supplied to a request scheduler. The request scheduler includes a request handler that determines a priority level of a current request. The request handler inserts the current request into a request priority queue according to the determined priority of the current request relative to the respective priority levels of other requests in the request priority queue. Requests in the request priority queue are supplied to a shared resource in order of their respective priority levels from the highest priority level to the lowest priority level. The shared resource provides responsive information or content in that order to the respective requesters.

### TECHNICAL FIELD OF THE INVENTION

The disclosures herein relate generally to processing requests for information in a network environment, and more particularly to processing of such requests in a network environment where resources to respond to requests may be limited.

### BACKGROUND

Networked systems continue to grow and proliferate. This is especially true for networked systems such as web servers and application servers that are attached to the Internet. These server systems are frequently called upon to serve up vast quantities of information in response to very large numbers of user requests.

Many server systems employ a simple binary (grant or deny) mechanism to control access to network services and resources. An advantage of such a control mechanism is that it is easy to implement because the user's request for access to the service or resource will be either granted or denied permission based on straightforward criteria such as the user's role or domain. Unfortunately, a substantial disadvantage of this approach is that the control of access to the resource is very coarse-grained. In other words, if access is granted, all users in the permitted roles will have the same access to the resource. In this case, resource availability is the same for all permitted users. This is not a problem when system resources are adequate to promptly handle all user requests. However, if multiple users request a single resource concurrently at peak load times, the user requests compete for the resource. Some user requests will be serviced while other user requests may wait even though all of these user requests should be honored.

What is needed is a method and apparatus for request handling without the above-described disadvantages.

### SUMMARY

Accordingly, in one embodiment, a method is disclosed for scheduling requests. A current request is supplied to a scheduler that determines a priority level for the current request. The scheduler inserts the current request into a request priority queue in a position related to the determined priority level of the current request relative to priority levels of other requests in the request priority queue. In this manner, requests are prioritized by respective priority levels in the request priority queue before being forwarded to a shared resource. The shared resource responds to the requests that are supplied thereto.

In another embodiment, a network system is disclosed that includes a request scheduler to which requests are supplied. The request scheduler includes a request handler that determines a priority level of a current request. The request scheduler also includes a request priority queue into which the current request is inserted in a position related to the determined priority level of the current request relative to priority levels of other requests in the request priority queue. Requests are thus prioritized in the request priority queue according to their respective priority levels before being forwarded to a shared resource for handling.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 is a block diagram of one embodiment of the disclosed network system.

FIG. 2 is a user priority look up table employed by the network system of FIG. 1.

FIG. 3A-3D illustrate the request priority queue in the scheduler of the disclosed network system.

FIG. 4 is a block diagram of another embodiment of the disclosed network system.

FIG. 5 is a flowchart illustrating the operation of one embodiment of the disclosed network system.

### DETAILED DESCRIPTION

In systems wherein all user requests to a shared network resource are granted or denied in a binary fashion, those user requests that are granted access will compete for the resource when network traffic peaks at a level beyond which all granted user requests can be promptly handled. Thus some user requests must wait for servicing even though they have the same access rights as those user requests that are immediately handled. It is desirable to provide a more fine-grained control than this binary grant/deny approach which results in disorganized contention for a limited network resource. Accordingly, in one embodiment of the disclosed method and apparatus, user requests are arranged in a request priority queue wherein the position of a request in the queue is determined by the priority level associated with the particular user generating that request. In this manner, higher priority requests are serviced before lower priority requests when peak resource loading conditions are encountered.

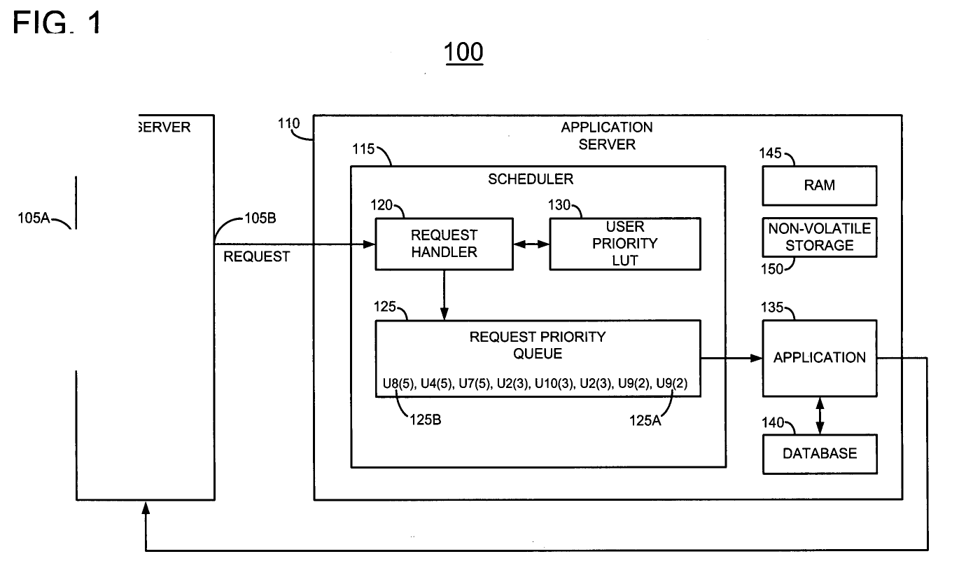

FIG. 1 is a block diagram of one embodiment of the disclosed network system 100. System 100 includes a web server 105 having an input 105A to which user requests, such as requests for information or content, are supplied. Input 105A is typically connected to the Internet although it can be connected to other networks as well. A user request typically originates from a user information handling system, such as a computer, data terminal, laptop/notebook computer, personal data assistant (PDA) or other information handling device (not shown), coupled to input 105A via network infrastructure therebetween.

Web server output 105B is coupled to an application server 110 as shown. Web server 105 receives user requests and forwards those requests to application server 110 for handling. Application server 110 includes a scheduler 115 having a request handler 120 to which user requests are supplied. Request handler 120 outputs requests to a request priority queue 125 in response to priority criteria stored in a user priority look up table (LUT) 130. More particularly, the requests are ordered in request priority queue 125 according to the priority criteria in LUT 130 as will be explained in more detail below.

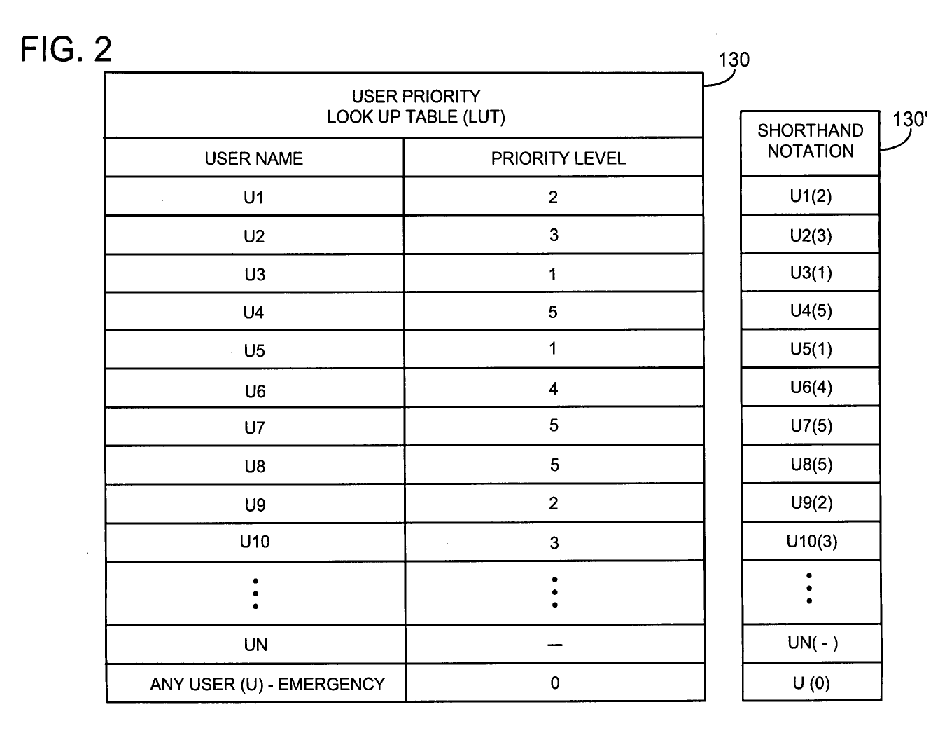

FIG. 2 shows a representative table that can be employed as user priority look up table (LUT) 130. In LUT 130, which is a form of storage, user names are designated U1, U2, U3, . . . UN wherein N is the total number of users that may be granted access to the shared resource, namely to information in application 135 and/or database 140. Each user is assigned a particular priority level. For example, in this representative embodiment, five non-emergency priority levels are used with priority level 1 being the highest priority level and priority level 5 being the lowest priority level. However, a greater or lesser number of priority levels may be employed depending on the amount of granularity desired in the particular application. It is noted that several users may be assigned the same priority level. It is also possible that one user may be the only user assigned to a particular priority level. In LUT 130, user U1 is assigned priority level 2; user U2 is assigned priority level 3; and user U3 is assigned priority level 1. LUT 130′ employs a shorthand notation for these entries. For example, in LUT 130′ U1(2) means that user U1 is assigned priority level 2; U2(3) means that user U2 is assigned priority level 3; and U3(1) means that user U3 is assigned priority level 3 and so forth. In one embodiment of the system, any user can request emergency service wherein the user's request will be prioritized ahead of other user requests having priority levels 1-5. When a user has designated his or her request as an emergency, that user's request is accorded a priority level of 0 and is placed in queue 125 ahead of other requests already in the queue. In another embodiment of the system, only a particular subset of users can request emergency service.

Returning to FIG. 1, it is noted that request priority queue 125 includes a head end 125A and a tail end 125B. Head end 125A supplies prioritized user requests to application 135. Application 135 performs whatever operations are necessary to retrieve or process the information requested by a particular user request. For example, application 135 may retrieve information from database 140 in the course of carrying out a particular user request. Alternatively, application 135 may process information derived from database 140 as prescribed by the request. Once the requested information or content is determined, the information is transmitted from application 135 in the application server 110 to web server 105 which then sends the requested information to the user making the user request.

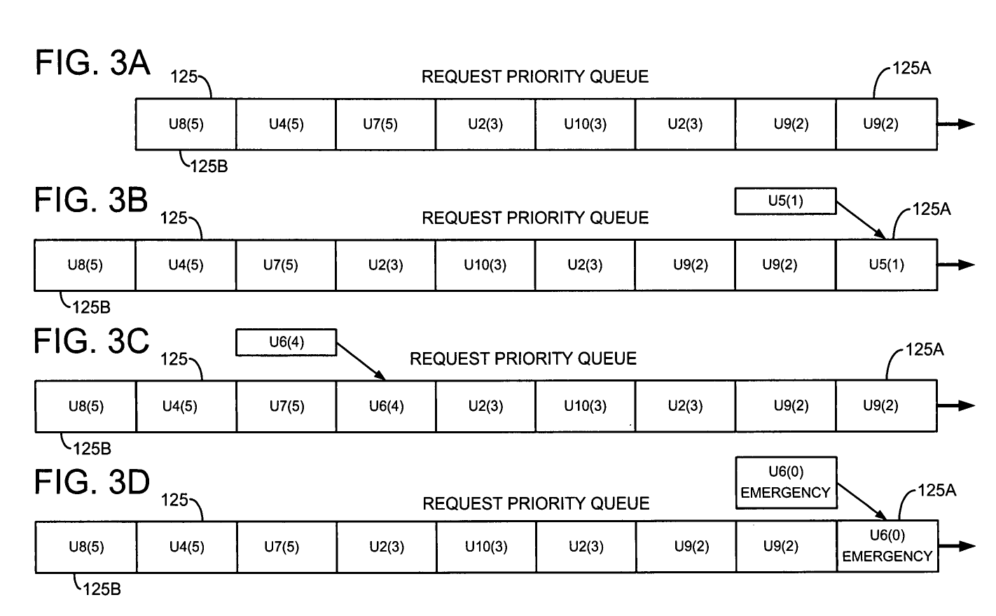

FIGS. 3A-3D illustrate the manner in which request priority queue 125 is populated with user requests. For purposes of example, it is assumed that priority queue 125 is initially populated with user requests in priority level order as shown in FIG. 3A. When request handler 120 receives a user request, handler 120 accesses user priority LUT 130 to determine the priority level to be accorded that request. Request handler 120 places requests with higher priority closer to the head 125A of the queue while placing lower priority requests closer to the tail 125B of the queue. Requests with priority level 1 are placed closer to the head of the queue than requests with priority level 2. Requests with priority level 3 are placed in the queue ahead of requests with priority level 4, and so forth.

In the FIG. 3A request priority queue example, a user request U9(2) is positioned at the head 125A of queue 125. Request U9(2) is a request from user U9 and is accorded a priority level 2. Another request U9(2) is positioned adjacent the U9(2) request at the head of the queue. Since these two requests exhibit the same priority level and there is no higher priority level request presently in the queue, request handler 120 inserts these requests at the head of the queue on a first come first served (FCFS) basis. The next following request, namely request U2(3), is a request from user U2 and is accorded a priority level 3 when request handler 120 accesses LUT 130. Thus, this U2(3) request is placed in the queue after the two user U9 priority level 2 requests, U9(2), discussed above. Consequently, application 135 services the U2(3) request after the two U9(2) requests. Request handler 120 places requests with the lowest priority level, namely level 5 in this example, at the tail end 125B of the queue. Application 135 services these lowest priority level requests after higher priority level requests are serviced.

FIG. 3B illustrates the operation of request priority queue 125 when a new user request, U5(1) is placed in the queue by request handler 120. Request handler 120 accesses LUT 130 and determines that the priority level to be accorded request U5(1) is a level 1 priority, the highest priority level in this particular example. Thus request handler 120 inserts user request U5(1) at the head 125A of queue 125 as shown in FIG. 3B. This effectively shifts the contents of queue 125, as it appears in FIG. 3A, left by one position thus resulting in the queue as shown in FIG. 3B. This action also effectively reprioritizes the user requests following user request U5(1) in the queue by causing them to be serviced later in time.

FIG. 3C depicts an alternative scenario in which a new user request, U6(4) is placed in the queue by request handler 120. Request handler 120 accesses LUT 130 and determines that the priority level to be accorded request U6(4) is a level 4 priority, a priority level which is lower than priority level 3 but higher than priority level 5. Thus request handler 120 inserts user request U6(4) in queue 125 in the position shown in FIG. 3C. More specifically, comparing FIG. 3C with FIG. 3A it is seen that user request U6(4) is placed in the queue between user request U2(3) and user request U7(5), thus shifting the contents of the queue following request U6(4) left by one position. This action effectively reprioritizes the user requests following user request U6(4) in the queue by causing them to be serviced later in time.

FIG. 3D depicts the emergency request handling scenario wherein user U6 sends a request U6(EMERG) that asks for emergency handling of the request. Request handler 120 receives this request and accesses LUT 130 to determine that user request U6(EMERG) should be accorded a priority level above all others, namely priority level 0. Request handler 120 then inserts request U6(EMERG), now designated U(0), at the head 125A of the queue so that this request is serviced immediately ahead of all other requests in the queue.

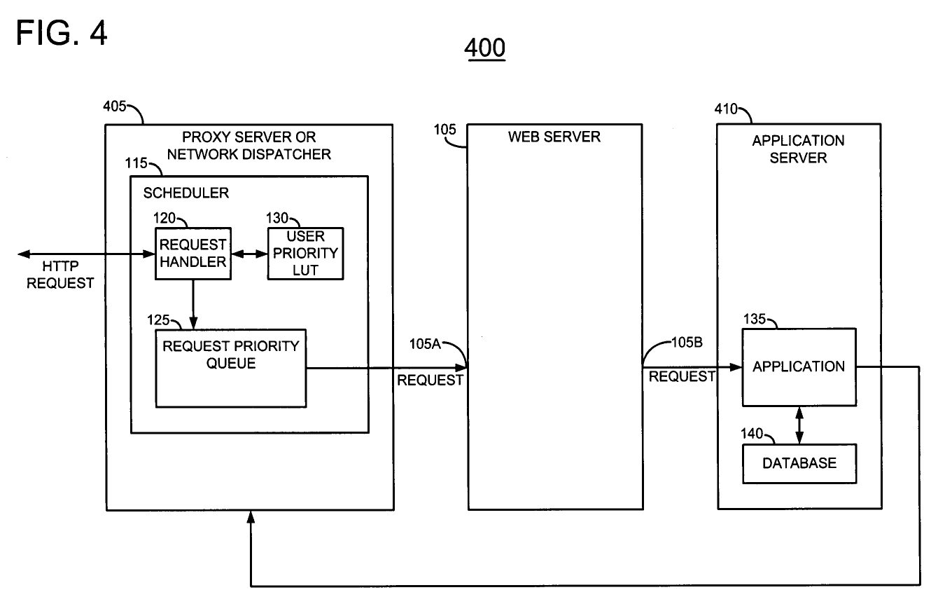

In the embodiment of FIG. 1, application server 110 includes scheduler 115 as well as application 135 and database 140. Another embodiment is possible wherein the scheduler is external to the application server as shown in network system 400 of FIG. 4. More particularly, scheduler 115 may be located in a proxy server or network dispatcher 405 which is situated ahead of web server 105 as shown. A proxy server is a server that acts as a firewall or filter that mediates traffic between a protected network and another network such as the Internet. A network dispatcher is a connection router that dispatches requests to a set of servers for load balancing. In comparing network system 400 of FIG. 4 with network system 100 of FIG. 1, like numerals are used to designate like components. Web server input 105A is coupled to request priority queue 125 of proxy server or network dispatcher 405 so that the prioritized requests flow to web server 105. Web server output 105B is coupled to application server 410 to channel the prioritized requests to application 135 and database 140 of application server 410. Those skilled in the art will appreciate that web server 105, proxy server/network dispatcher 405 and application server 410 may be implemented as separate hardware blocks or may be grouped together in one or more hardware blocks depending upon the particular implementation. While in the embodiment shown there is one web server, other embodiments are possible using multiple web servers coupled to proxy server/network dispatcher 405. The multiple web servers are respectively coupled to multiple application servers to enable the web servers to carry out prioritized requests that they receive from the web servers. In this scenario, user requests in the request priority queue 125 are routed by the proxy server/network dispatcher 405 to one of the available web servers which then directs the request to one of multiple application servers 410 for servicing.

In one embodiment of the disclosed network system, requests are handled by request handler 120 on a first come first served (FCFS) basis when loading of a shared resource, such as application 135/database 140 is relatively low, as determined by scheduler 115. Scheduler 115 controls access to application 135 and database 140. Scheduler is thus apprised of the loading of this resource so that it knows whether an incoming current request can be immediately serviced. If the loading on the shared resource is sufficiently low that a current request can be immediately serviced by the shared resource, then the request is given immediate access to the shared resource. However, when loading of the shared resource exceeds a predetermined threshold level, such that a request can no longer be immediately serviced and contention might otherwise result, then scheduler 115 is triggered to populate request priority queue 125 according to the respective priority levels assigned to those requests in LUT 130 as described above.

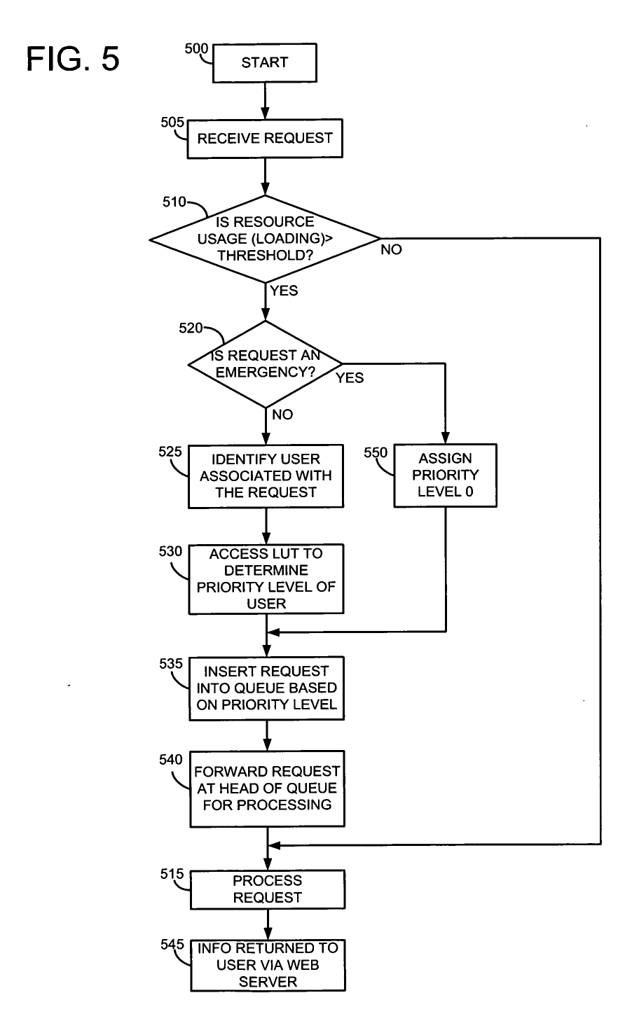

FIG. 5 is a flow chart which depicts the methodology employed in one embodiment of the disclosed network system. Operation commences at start block 500. The system receives a request for access to a shared resource such as an application or database or other information as per block 505. Scheduler 115 determines if current resource usage exceeds a predetermined threshold as per decision block 510. In one embodiment, the threshold is set at a level of resource use such that contention for the resource starts to occur when the threshold is exceeded. If a particular new request, i.e. a current request, would not cause the threshold to be exceeded, then flow continues to block 515 and the request is immediately serviced by the shared resource. In other words, when loading of the shared resource is so low that contention would not occur, incoming requests are handled on a first come-first served (FCFS) basis by the shared resource. However, if the current loading or resource usage is sufficiently high that the threshold would exceeded if the current request were to be serviced, then the above described prioritization methodology is applied to such user requests. In that case, process flow continues to decision block 520 at which a test is conducted to determine if the current request is an emergency request. If the current request is not an emergency request, then scheduler 115 identifies the user associated with the current request as per block 525. Scheduler 115 then accesses LUT 130 to determine the particular priority level to be accorded the current request as per block 530. The request handler 125 of scheduler 115 then inserts the current request into request queue 125 according to the priority level associated with that request as per block 535. Requests with higher priority are placed closer to the head of the queue than requests with lower priority. The request at the head of the priority queue is forwarded to application 135 as per block 540. Application 135 then processes the request as per block 515. The requested data or content is returned to the requesting user via web server 105 as per block 545. It is noted that if at decision block 520, the current request is found to be an emergency request, then a priority level of 1 is assigned to the current request as per block 545. Process flow then proceeds immediately to block 515 and the request is processed ahead of other requests that are in the queue.

Returning to decision block 520, a test is conducted to determine if the current request is an emergency request. In one embodiment, any user can request emergency service. To denote a request for emergency service, the request includes an emergency flag that is set when emergency service is requested. As discussed above, if the request is not an emergency request, then process flow continues normally to block 525 and subsequent blocks wherein the request is prioritized and placed in the request priority queue in a position based on its priority level. However, if decision block 520 detects that a particular request has its emergency flag set, then the request is treated as an emergency request. Such a request is accorded a priority of 0 which exceeds all other priority levels in this embodiment. Since the emergency request exhibits a priority level of 0, it is placed at the head of the request priority queue and/or is sent immediately to the application server for processing ahead of other requests in the queue.

Many different criteria may be used to assign the priority level of a particular user. Users with mission critical requirements may be assigned high priority levels such as priority level 1 or 2 in the above example. General users with no particular urgency to their requests may be assigned a lower priority level such as priority level 4 or 5. Users can also be assigned priority levels according to the amount they pay for service. Premium paying users may be assigned priority level 1. Users paying a lesser amount could be assigned priority level 2 and 3 depending on the amount they pay for service. Users who are provided access for a small charge or for no charge may be assigned priority levels 4 and 5, respectively. Other criteria such as the user's domain or the user's role in an organizational hierarchy can also be used to determine the user's priority level. When the shared resource, namely application 135/database 140 in this particular example, is determined to be too busy, user requests can be forward to another server that is less busy.

Those skilled in the art will appreciate that the various structures disclosed, such as request handler 120, user priority LUT 130, request priority queue 125, application 135 and database 140 can be implemented in hardware or software. Moreover, the methodology represented by the blocks of the flowchart of FIG. 5 may be embodied in a computer program product, such as a media disk, media drive or other media storage.

In one embodiment, the disclosed methodology is implemented as a client application, namely a set of instructions (program code) in a code module which may, for example, be resident in a random access memory 145 of application server 110 of FIG. 1. Until required by application server 110, the set of instructions may be stored in another memory, for example, non-volatile storage 150 such as a hard disk drive, or in a removable memory such as an optical disk or floppy disk, or downloaded via the Internet or other computer network. Thus, the disclosed methodology may be implemented in a computer program product for use in a computer such as application server 110. It is noted that in such a software embodiment, code which carries out the functions of scheduler 115 may be stored in RAM 145 while such code is being executed. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

A network system is thus provided that prioritizes user requests in a request priority queue to provide fine-grained control of access to a shared network resource. Concurrent requests to the shared resource when the network system is operating in peak load conditions are prioritized within the request queue as described above. However, when loading of the network system is low, requests to the shared resource may be handled in a first come, first served basis in one embodiment.

Modifications and alternative embodiments of this invention will be apparent to those skilled in the art in view of this description of the invention. Accordingly, this description teaches those skilled in the art the manner of carrying out the invention and is intended to be construed as illustrative only. The forms of the invention shown and described constitute the present embodiments. Persons skilled in the art may make various changes in the shape, size and arrangement of parts. For example, persons skilled in the art may substitute equivalent elements for the elements illustrated and described here. Moreover, persons skilled in the art after having the benefit of this description of the invention may use certain features of the invention independently of the use of other features, without departing from the scope of the invention.

What is claimed is:

1. A method of scheduling requests comprising:
supplying a current request to a scheduler;
determining a priority level for the current request; and
inserting the current request into a request priority queue in a position related to the determined priority level of the current request relative to priority levels of other requests in the request priority queue.

2. The method of claim 1 wherein determining a priority level for the current request further comprises accessing a storage that includes priority level information for respective users.

3. The method of claim 2 wherein the storage includes a look-up table.

4. The method of claim 1 wherein inserting the current request into a request priority queue further comprises positioning higher priority requests near a head of the request priority queue and positioning lower priority requests near a tail of the request priority queue.

5. The method of claim 4 further comprising servicing a request at the head of the request priority queue by a shared resource.

6. The method of claim 1 further comprising supplying a request from the request priority queue to a shared resource, the shared resource providing information in response to such request.

7. The method of claim 6 including determining if loading on the shared resource exceeds a predetermined threshold.

8. The method of claim 7 wherein inserting the current request in the request priority queue further comprises providing the current request and other requests to the shared resource on an FCFS basis if the threshold is not exceeded, and otherwise providing the current request to the request priority queue in a position related to the determined priority of the current request relative to other requests in the request priority queue.

9. The method of claim 8 wherein requests in the request priority queue are reprioritized when a current request is placed in the request priority queue.

10. A network system for scheduling requests comprising:
a scheduler to which requests are supplied, the scheduler including:
a request handler that determines a priority level of a current request; and
a request priority queue, coupled to the request handler, into which a current request is inserted in a position related to the determined priority level of the current request relative to priority levels of other requests in the request priority queue.

11. The network system of claim 10 further comprising a shared resource coupled to the scheduler.

12. The network system of claim 11 wherein the shared resource includes an application.

13. The network system of claim 11 wherein the shared resource includes a database.

14. The network system of claim 10 wherein the scheduler includes a look-up table in which priority level information is stored for respective users.

15. The network system of claim 11 wherein the scheduler determines if loading on the shared resource exceeds a predetermined threshold.

16. The network system of claim 15 wherein the request handler provides the current request and other requests to the shared resource on an FCFS basis if the predetermined threshold is not exceeded, and otherwise provides the current request to the request priority queue in a position related to the determined priority of the current request relative to other requests in the request priority queue.

17. The network system of claim 10 wherein the request priority queue reprioritizes requests therein when a current request is placed in the request priority queue.

18. The network system of claim 10 further comprising a web server, coupled to the scheduler, that forwards requests for content to the scheduler.

19. A computer program product stored on a computer operable medium for prioritizing requests, the computer program product comprising:
means for supplying a request to a scheduler;
means for determining a priority level for a current request; and
means for inserting the current request into a request priority queue in a position related to the determined priority level of the current request relative to priority levels of other requests in the request priority queue.

20. The computer program product of claim 19 wherein the means for determining a priority level of the current request includes means for accessing a storage that includes priority level information for respective users.

21. The computer program product of claim 19 further comprising means for determining if loading on a shared resource by requests exceeds a predetermined threshold.

22. The computer program product of claim 21 wherein the means for inserting the current request into a request priority queue includes means for providing the current request and other requests to the shared resource on an FCFS basis if the predetermined threshold is not exceeded, and otherwise providing the current request to the request priority queue in a position related to the determined priority of the current request relative to other requests in the request priority queue.
